(19) United States
(12) Patent Application Publication
(10) Pub. No.: US 2009/0041013 A1
(43) Pub. Date: Feb. 12, 2009

(54) Dynamically Assigning A Policy For A Communication Session

(76) Inventors: Nathan A. Mitchell, Siler City, NC (US); Richard L. Gray, Cary, NC (US); Robert A. Mackie, Cary, NC (US); Walter G. Dixon, Fuquay Varina, NC (US); Clarence L. Deitrich, Raleigh, NC (US); Mark Albert, Cary, NC (US)

Correspondence Address: BAKER BOTTS L.L.P., 2001 ROSS AVENUE, SUITE 600, DALLAS, TX, 75201-2980, US

(21) Appl. No.: 11/835,098

(22) Filed: Aug. 7, 2007

(51) Int. Cl. H04L 12/56

(52) U.S. Cl. 370/392

(57) ABSTRACT

In one embodiment, assigning a policy to a communication session includes facilitating the communication session for an endpoint. Policy data is determined from one or more messages communicated subsequent to communication of a request message requesting a service for the endpoint. A policy is assigned to the communication session in accordance with the policy data.

### TECHNICAL FIELD

This invention relates generally to the field of communication networks.

### BACKGROUND

In certain communication networks, a content server may provide content to an endpoint. A billing system may determine how much the endpoint is to be charged for the service. Known billing systems, however, may not be able to effectively obtain information to determine how much the endpoint should be charged.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates one embodiment of a system that provides services to an endpoint;

FIG. 2 illustrates one embodiment of a method for aggregating packet flows of a transaction that may be used by the system of FIG. 1; and

FIG. 3 illustrates one embodiment of a method for determining a policy for a packet flow that may be used by the system of FIG. 1.

### DETAILED DESCRIPTION OF THE DRAWINGS

Overview

According to one embodiment of the present invention, assigning a policy to a communication session includes facilitating the communication session for an endpoint. Policy data is determined from one or more messages communicated subsequent to communication of a request message requesting a service for the endpoint. A policy is assigned to the communication session in accordance with the policy data.

According to another embodiment of the present invention, aggregating packet flows of a transaction includes facilitating the transaction for an endpoint. The following is repeated for each packet flow of the transaction: receiving a packet flow, identifying the packet flow as a packet flow of the transaction, and associating the packet flow with the transaction.

Description

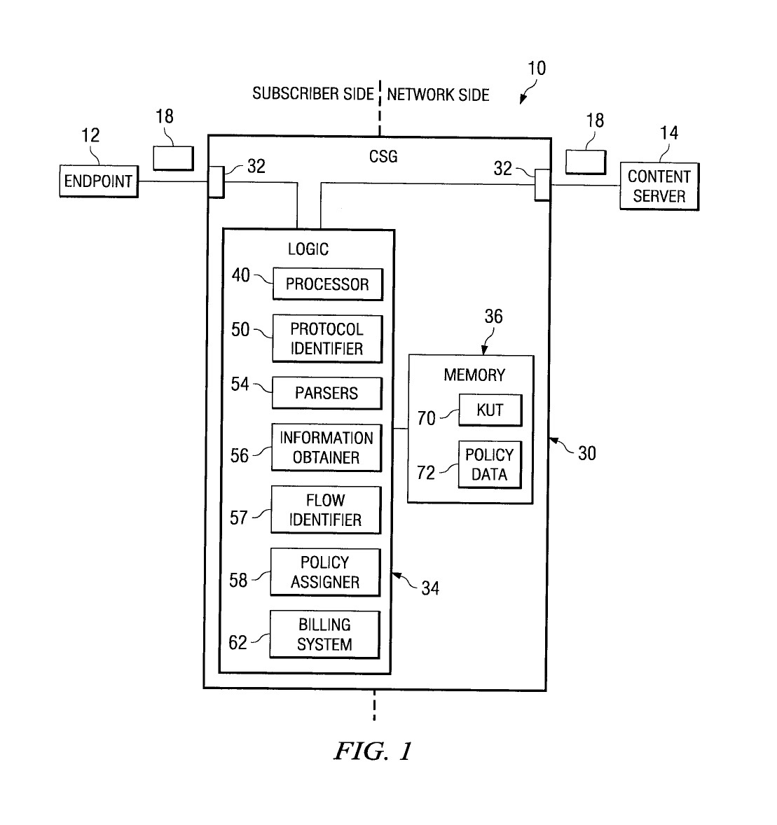

FIG. 1 illustrates one embodiment of a system 10 in which services, for example, content services, are provided to an endpoint 12. In one embodiment, policy data may be determined from a message sent subsequent to communication of a request message requesting a service. For example, the policy data may be determined from a response message responding to the request message. A policy may be assigned using the policy data. The subsequent message may have more data than the request message, so the policy may be more accurately assigned. Also in the embodiment, the policy may be dynamically assigned in response to updated policy data received in subsequent messages. For example, updated policy data may indicate a change in the service. An updated policy may be assigned in response to the change.

In another embodiment, packet flows of a particular transaction may be aggregated. For example, a content server sends a file in multiple packet flows as part of one transaction. The packet flows may be aggregated by associating the packet flows with the transaction. Aggregating the packet flows may allow for more accurate billing for the transaction. In the embodiment, a previous packet flow of a transaction may be used to identify a subsequent packet flow as belonging to the transaction. For example, a packet flow of a transaction may request data of a particular type. A subsequent packet flow that provides the data may be identified as belonging to the transaction.

In the illustrated embodiment, communication system 10 includes an endpoint (EP) 12, a content services gateway (CSG) 30, and a content server (CS) 14 coupled as shown. Endpoint 12 represents any suitable component operable to communicate with a communication system. Examples of endpoint 12 include a telephone, a personal digital assistant, a computer, a mobile handset, or any other device operable to communicate with system 10.

According to the illustrated embodiment, system 10 provides communication sessions to endpoints 12. A communication session may refer to an active communication of packets 18. A packet 18 comprises a bundle of data organized in a specific way for transmission. According to one embodiment, packet 18 may be tunneled. Tunneling may refer to the process of encapsulating one packet into another packet, for example, encapsulating a data packet in an Internet Protocol (IP) packet for transmission across an IP network. Examples of tunneling protocols include GPRS tunneling protocol, IP security (IPsec) protocol, Layer 2 Tunneling Protocol (L2TP), Point-to-Point Tunneling Protocol (PPTP), and Sockets (SOCKS) protocol.

As a packet is encapsulated in another packet, a new tunnel layer is formed. Thus, the resulting packet 18 may have multiple tunnel layers. Moreover, each tunnel layer may be encapsulated according to a different protocol. Examples of protocols include Microsoft Media Services (MMS), Wireless Access Protocol (WAP), Wireless Village (WV) protocol, hypertext transfer protocol (HTTP), extensible markup language (XML), or other protocol. Packets 18 may be tunneled using any suitable protocols in any suitable order, for example, MMS over WAP, MMS over HTTP, MMS over WAP2 over HTTP, and MMS over WV over XML over HTTP.

A packet flow comprises packets 18 sent from a source to a destination, and may be identified by a flow identifier that includes identifiers for the source and/or destination of the packet flow. A source and/or destination may be identified by an IP address and/or port of the source and/or destination. Different flows may use different connections, for example, different access points and/or different transport mechanisms.

During a communication session, a service may be provided to endpoint 12 as a transaction. In one embodiment, content server 14 provides content to endpoint 12 as part of a content service. In certain cases, a transaction may use multiple packet flows. As a first example, content server 14 provides a file, such as a Portable Document Format (PDF) file, to endpoint 12 in pieces, where each piece is communicated by a different packet flow. As a second example, content server 14 provides content to endpoint 12 multiple times, but endpoint 12 should only be charged once. As a third example, content server 14 may provide different scripts of a webpage in different flows.

A transaction may be split across different transport media (for example, Short Message Service (SMS) and IP), Transmission Control Protocol (TCP) connections, and/or originating nodes (such as endpoint 12 or content provider 14). Certain protocols may split a transaction across different HTTP and/or TCP connections. Examples of such protocols include Wireless Village and MMS/WAP2/HTTP.

CSG 30 monitors information within a packet flow to provide communication operations such as access control and/or accounting operations. In one embodiment, CSG 30 may determine policy data from a message sent subsequent to communication of a request message requesting a service. For example, the policy data may be determined from a response message responding to the request message. Zero, one, or more messages may be communicated between a message and a subsequent message.

CSG 30 may then assign a policy (such as a billing policy) using the policy data. The subsequent message may have more data than the request message, so the policy may be more accurately assigned. CSG 30 may also dynamically assign a policy in response to updated policy data received in subsequent messages. For example, updated policy data may indicate a change in a service. An updated policy may be assigned in response to the change.

In one embodiment, CSG 30 may aggregate the packet flows of a particular transaction by associating the packet flows with the transaction. For example, content server 14 sends a file in multiple packet flows as part of one transaction. CSG 30 associates the multiple packet flows with the transaction. In the embodiment, CSG 30 may use a previous packet flow of a transaction to identify a subsequent packet flow as belonging to the transaction. For example, a packet flow of a transaction may request data of a particular type. A subsequent packet flow that provides the data may be identified as belonging to the transaction.

In one embodiment, CSG 30 may obtain policy data from packets 18 that have multiple tunnel layers. For example, at each tunnel layer, CSG 30 may identify a protocol associated with the tunnel layer and parse the packet according to the identified protocol. CSG 30 may process the tunnel layers until a target layer that includes the policy data is reached. When the target layer is reached, CSG 30 may extract the policy data from the target layer.

CSG 30 may include any suitable elements for obtaining policy data, assigning a policy, and/or aggregating packet flows. In the illustrated embodiment, CSG 30 includes interfaces 32, logic 34, and a memory 36. Logic 34 may include a processor 40 and applications such as a protocol identifier 50, parsers 54, an information obtainer 56, a flow identifier 57, a policy assigner 58, and a billing system 62. Memory 36 may include a known user table (KUT) 70.

In one embodiment, interface 32 receives input, sends output, processes the input and/or output, and/or performs other suitable operation. Interface 32 may comprise hardware and/or software. Logic 34 performs the operations of CSG 30, for example, logic may execute instructions to generate output from input. Logic 34 may include hardware, software, other logic, or a combination of any of the preceding. Processor 40 manages the operation of CSG 30, and may perform the operations of CSG 30 by executing applications. Examples of processor 10 may include one or more computers, one or more microprocessors, one or more applications, other logic, or a combination of any of the preceding.

Protocol identifier 50 identifies protocols of the tunnel layers of packet 18. Protocol identifier 50 may identify a protocol in any suitable manner. As an example, a communications standard may designate that particular tunnel layers are associated with particular protocols. As another example, a previous tunnel layer may indicate the protocol of a next tunnel layer. As yet another example, a first portion of a tunnel layer may indicate the protocol of a second portion of the tunnel layer. Parsers 50 parse packet 18 according to the protocol of the tunnel layer in order to reach the next tunnel layer. Parsers 54 may include parsers for specific protocols.

Information obtainer 56 obtains policy data from a target layer. Policy data is used to select a billing policy to apply to a packet flow in order to charge endpoint 12 for the packet flow. For example, the policy data may include an endpoint identifier, a user identifier, a billing code, and/or other suitable information.

In one embodiment, endpoint 12 sends a content request message requesting a content service. The policy data may be in one or more messages communicated subsequent to the communication of the content request message. For example, the policy data may be in a content response message that responds to the content request message or in a termination message that terminates the content service.

Information obtainer 56 may identify the policy data in any suitable manner. According to one embodiment, information obtainer 56 may be programmed to obtain the policy data from a tunnel layer associated with a specific protocol. For example, information obtainer 56 may be programmed to obtain data from an MMS tunnel layer. If protocol identifier 50 identifies the protocol of a tunnel layer as MMS, information obtainer 56 may obtain the data from that tunnel layer.

Flow identifier 57 identifies a particular packet flow as belonging to a transaction and associates the packet flow with the transaction. In one embodiment, the packet flow is associated with a transaction by mapping a packet flow identifier identifying the packet flow with a transaction identifier identifying the transaction.

Flow identifier 57 may identify flows that belong to the same transaction in any suitable manner. In one embodiment, endpoint 12 sends a request message requesting an item for a transaction. Content server 14 sends a response message that provides the requested item. The response message may be regarded as belonging to the same transaction. As an example, an outstanding request and an outstanding response received closest in time after receiving the request may be regarded belonging to the same transaction. As another example, a request for a particular data type (for example, a particular URL and/or byte range) and a response that provides the data type may be regarded as belonging to the same transaction.

In another embodiment, content server 14 sends multiple response messages that belong to the same transaction. As an example, a response message may include a webpage with a manifest of one or more subset objects, such as a button and a logo. Subsequent responses that include the subset objects may be regarded as belonging to the same transaction. As another example, content server 14 may send multiple response messages that include the same material by mistake. The multiple response messages may be regarded as belonging to the transaction.

Flow identifier 57 may also determine the start and/or end of a transaction. A service request message from endpoint 12 may indicate the start of a transaction. A termination message from or a timeout at endpoint 12 and/or content server 14 may indicate the end of a transaction.

Policy assigner 58 determines a policy for a packet flow. Policy assigner 58 may determine one or more policies according to policy data obtained from one or more messages received subsequent to communication of a request message. Policy assigner 58 may also reassign a policy as endpoint 12 changes its requests. For example, endpoint 12 may first request an instant messaging service and then request a chat service.

In one embodiment, policy assigner 58 may determine a billing policy for a packet flow, and may notify billing system 62 of the policy. Billing system 62 charges endpoint 12 according to the policy provided by policy assigner 58.

Memory 36 stores information. Memory 36 may comprise computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), other computer-readable medium, or a combination of any of the preceding.

Memory 36 stores known user table (KUT) 70 and policy data 72 obtained from messages. KUT 70 stores information about communication sessions that system 10 is facilitating. The information may be indexed according to the endpoints 12 involved in the communication sessions. For example, KUT 70 may include identifiers of endpoints 12 (such as IP addresses of endpoints 12), and may associate information related to an endpoint 12 with the identifier of the endpoint 12. According to one embodiment, KUT 70 stores policy data obtained from one or more packets 18.

According to another embodiment, KUT 70 stores information related to a particular transaction. The transaction may have a transaction identifier. Packet identifiers of packet flows of a particular transaction may be mapped to the transaction identifier of the transaction. The associated flows may be tracked in order to charge a subscriber for the transaction.

Content server 14 represents an entity that provides content to subscribers such as endpoint 12 as part of a content service. Content server 14 may include a server that may be accessed by endpoint 12 to provide the content.

System 10 may include one or more networks that allow the components of system 10 to communicate. A communication network may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of any of the preceding.

System 10 may utilize any suitable communication protocols and/or technologies. Examples of communication protocols and technologies include those set by the Institute of Electrical and Electronics Engineers, Inc. (IEEE) 802.xx standards, the International Telecommunications Union (ITU-T) standards, the European Telecommunications Standards Institute (ETSI) standards, the Internet Engineering Task Force (IETF) standards, or other standards. In one embodiment, system 10 may utilize ETSI communication protocols such as Global System for Mobile Communications (GSM) protocols that use General Packet Radio Services (GPRS) tunneling protocols.

Modifications, additions, or omissions may be made to system 10 without departing from the scope of the invention. The components of system 10 may be integrated or separated. Moreover, the operations of system 10 may be performed by more, fewer, or other components. For example, the operations of protocol identifier 50 and parsers 54 may be performed by one component, or the operations of billing system 62 may be performed by more than one component. Additionally, operations of system 10 may be performed using any suitable logic. As used in this document, “each” refers to each member of a set or each member of a subset of a set.

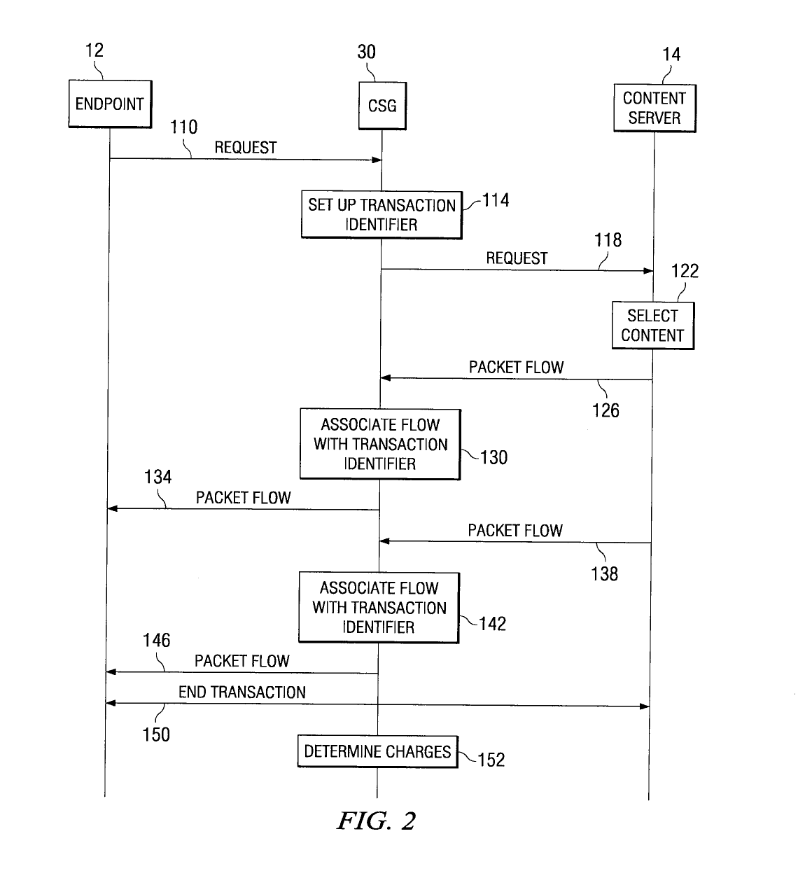

FIG. 2 illustrates one embodiment of a method for aggregating packet flows that may be used by system 10 of FIG. 1. The method begins at step 110, where endpoint 12 sends a content request to request a content service. CSG 30 sets up a transaction identifier for the content service transaction at step 114. CSG 30 forwards the content request to content server 14 at step 118.

Content server 14 selects the content at step 122. The content may include a web page that has a manifest indicating subset objects, such as a logo. Content server 14 send a packet flow that includes a response message with the content to CSG 30 at step 126. CSG 30 identifies the response message as responding to the request message, and associates the packet flow with the transaction at step 130. A packet flow is associated with a transaction by mapping a packet flow identifier identifying the packet flow to a transaction identifier identifying the transaction. CSG 30 forwards the packet flow to endpoint 12 at step 134.

Content server 14 sends a subsequent packet flow that includes a subset object at step 138. For example, the packet flow may include the logo. CSG 30 identifies the flow as belonging to the transaction based upon the manifest of the previous packet flow, and associates the packet flow with the transaction at step 142. CSG 30 forwards the subsequent packet flow to endpoint 12 at step 146.

The transaction ends at step 150. CSG 30 determines the charges for the complete transaction at step 152. Charges may be determined based upon the aggregated packet flows. After determining the charges, the method ends.

Modifications, additions, or omissions may be made to the method without departing from the scope of the invention. The method may include more, fewer, or other steps. Additionally, steps may be performed in any suitable order.

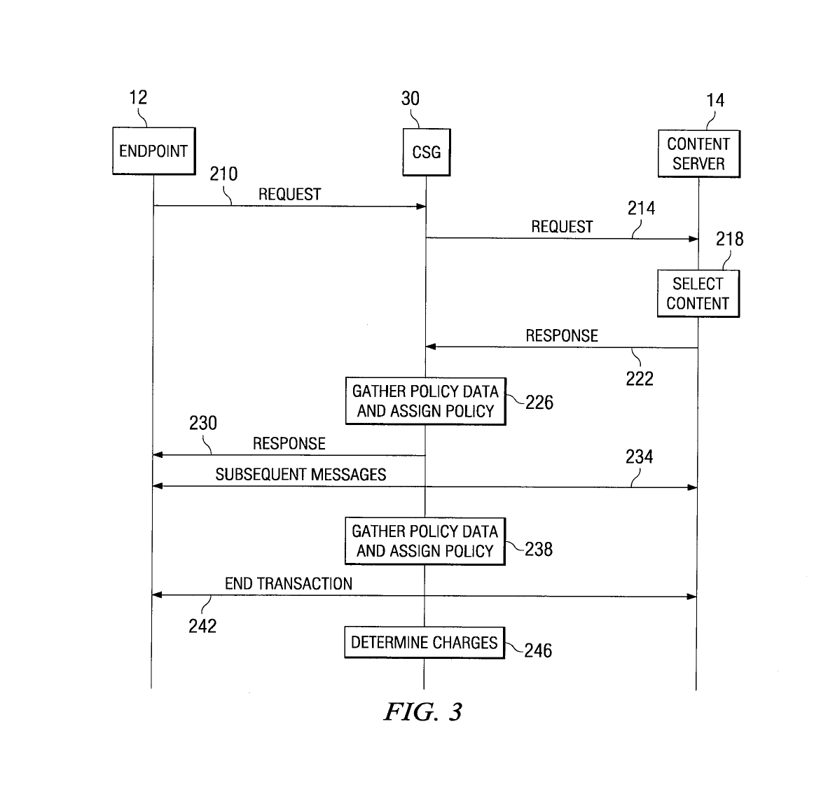

FIG. 3 illustrates one embodiment of a method for assigning a policy that may be used by system 10 of FIG. 1. The method begins at step 210, where endpoint 12 sends a request message requesting a content service to CSG 30. CSG 30 forwards the request message to content server 14 at step 214. Content server selects the requested content at step 218. Content server 14 sends the selected content in a response message at step 222. CSG 30 gathers policy data from the response message and assigns a billing policy at step 226.

CSG 30 forwards the response message to endpoint 12 at step 230. Subsequent messages are communicated at step 234. Subsequent messages may indicate that endpoint 12 has changed services. CSG 30 gathers updated policy data from a subsequent message and dynamically assigns an updated policy at step 238. The transaction is terminated at step 242. CSG 30 determines the charges for the transaction at step 246. Charges may be determined based upon the one or more policies assigned during the transaction. After determining the charges, the method ends.

Modifications, additions, or omissions may be made to the method without departing from the scope of the invention. The method may include more, fewer, or other steps. Additionally, steps may be performed in any suitable order.

Certain embodiments of the invention may provide one or more technical advantages. A technical advantage of one embodiment may be that policy data is determined from a message sent subsequent to communication of a request message requesting a service. For example, the policy data may be determined from a response message responding to the request message. A policy is assigned using the policy data. The subsequent message may have more data than the request message, so the policy may be more accurately assigned.

Another technical advantage of one embodiment may be that the policy may be dynamically assigned in response to updated policy data received in subsequent messages. For example, updated policy data may indicate a change in a service. An updated policy may be assigned in response to the change.

Another technical advantage of one embodiment may be that packet flows of a particular transaction may be aggregated. For example, a content server may send a file in multiple packet flows as part of one transaction. The packet flows may be aggregated by associating the packet flows with the transaction. Aggregating the packet flows may allow for more accurate billing for the transaction.

Another technical advantage of one embodiment may be that a previous packet flow of a transaction may be used to identify a subsequent packet flow as belonging to the transaction. For example, a packet flow of a transaction may request data of a particular type. A subsequent packet flow that provides the data may be identified as belonging to the transaction.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method, comprising:
facilitating a communication session for an endpoint;
determining policy data from one or more messages, the one or more messages communicated subsequent to communication of a request message requesting a service for the endpoint; and
assigning a policy to the communication session in accordance with the policy data.

2. The method of claim 1, wherein:
the request message further comprises a content request message requesting the service comprising a content service; and
a message of the one or more messages further comprises a content response message responding to the content request message.

3. The method of claim 1, wherein:
a message of the one or more messages further comprises a terminating message terminating the service.

4. The method of claim 1, wherein determining the policy data from one or more messages further comprises:
obtaining the policy data from one or more tunnel layers of the one or more messages.

5. The method of claim 1, wherein the policy further comprises a billing policy.

6. The method of claim 1, further comprising:
determining updated policy data from at least one additional message communicated subsequent to the one or more messages; and
assigning an updated policy in accordance with the updated policy data.

7. A system, comprising:
a memory operable to store policy data; and
one or more processors coupled to the memory and operable to execute one or more applications to:
facilitate a communication session for an endpoint;
determine the policy data from one or more messages, the one or more messages communicated subsequent to communication of a request message requesting a service for the endpoint; and
assign a policy to the communication session in accordance with the policy data.

8. The system of claim 7, wherein:
the request message further comprises a content request message requesting the service comprising a content service; and
a message of the one or more messages further comprises a content response message responding to the content request message.

9. The system of claim 7, wherein:
a message of the one or more messages further comprises a terminating message terminating the service.

10. The system of claim 7, wherein the one or more processors are further operable to determine the policy data from one or more messages by:
obtaining the policy data from one or more tunnel layers of the one or more messages.

11. The system of claim 7, wherein the policy further comprises a billing policy.

12. The system of claim 7, wherein the one or more processors are further operable to:
determine updated policy data from at least one additional message communicated subsequent to the one or more messages; and
assign an updated policy in accordance with the updated policy data.

13. A system, comprising:
means for facilitating a communication session for an endpoint;
means for determining policy data from one or more messages, the one or more messages communicated subsequent to communication of a request message requesting a service for the endpoint; and
means for assigning a policy to the communication session in accordance with the policy data.

14. A method, comprising:
facilitating a transaction for an endpoint; and
repeating the following for each packet flow of a plurality of packet flows of the transaction:
receiving the each packet flow;
identifying the each packet flow as a packet flow of the transaction; and
associating the each packet flow with the transaction.

15. The method of claim 14, further comprising:
determining a charge for the transaction according to the plurality of packet flows associated with the transaction.

16. The method of claim 14, wherein identifying the each packet flow as a packet flow of the transaction further comprises:
establishing from a previous packet flow that the each packet flow is a packet flow of the transaction.

17. The method of claim 14, wherein identifying the each packet flow as a packet flow of the transaction further comprises:
establishing that an outstanding request is associated with the transaction; and
determining that the each packet comprises an outstanding response responding to the outstanding request.

18. The method of claim 14, wherein identifying the each packet flow as a packet flow of the transaction further comprises:
receiving a request that requests data; and
establishing that the each packet flow comprises the data.

19. The method of claim 14, wherein identifying the each packet flow as a packet flow of the transaction further comprises:
receiving a response comprising a manifest of one or more subset objects; and
establishing that the each packet flow comprises the one or more subset objects.

20. A system, comprising:
a memory operable to store information for facilitating a transaction for an endpoint; and
one or more processors operable to execute one or more applications to repeat the following for each packet flow of a plurality of packet flows of the transaction:
receive the each packet flow;
identify the each packet flow as a packet flow of the transaction; and
associate the each packet flow with the transaction.

21. The system of claim 20, the one or more processors further operable to:
determine a charge for the transaction according to the plurality of packet flows associated with the transaction.

22. The system of claim 20, the one or more processors further operable to identify the each packet flow as a packet flow of the transaction by:
establishing from a previous packet flow that the each packet flow is a packet flow of the transaction.

23. The system of claim 20, the one or more processors further operable to identify the each packet flow as a packet flow of the transaction by:
establishing that an outstanding request is associated with the transaction; and
determining that the each packet comprises an outstanding response responding to the outstanding request.

24. The system of claim 20, the one or more processors further operable to identify the each packet flow as a packet flow of the transaction by:
receiving a request that requests data; and
establishing that the each packet flow comprises the data.

25. The system of claim 20, the one or more processors further operable to identify the each packet flow as a packet flow of the transaction by:
receiving a response comprising a manifest of one or more subset objects; and
establishing that the each packet flow comprises the one or more subset objects.

26. A system, comprising:
means for facilitating a transaction for an endpoint; and
means for repeating the following for each packet flow of a plurality of packet flows of the transaction:
receiving the each packet flow;
identifying the each packet flow as a packet flow of the transaction; and
associating the each packet flow with the transaction.
